(19) United States
(12) Patent Application Publication
(10) Pub. No.: US 2005/0026558 A1
(43) Pub. Date: Feb. 3, 2005

(54) Access flow based charging for IMS/POC services

(76) Inventors: Marco Stura, Espoo (FI); Erdei Erzsebet, Budapest (HU); Juha Pekka Koskinen, HML (FI); Anne Narhi, Tampere (FI); Balazs Bertenyi, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/840,506

(22) Filed: May 7, 2004

(30) Foreign Application Priority Data
May 7, 2003 (EP) 03 010 272.7

(51) Int. Cl. H04H 7/00

(52) U.S. Cl. 455/3.06

(57) ABSTRACT

A method and system of flow based charging for IP multimedia system services are disclosed. The system includes a call processing server, and a session charging functionality. The method comprises negotiating media to be used within a session during a session initiating signaling. The method also includes generating a set of charging flow identifiers according to a predefined mechanism. The set of charging flow identifiers are associated with respective charging identifiers of the IP multimedia system identifying the session. A charging identifier of the IP multimedia system and a charging flow identifier globally uniquely identify a media component within a session. The call processing server and the session charging functionality generate the same charging flow identifiers by using the predefined mechanism so that the charging flow identifiers are known before any resource reservation occurs.

### FIELD OF THE INVENTION

The present invention relates to a method and-system for access flow based charging for IP multimedia system services. The present invention is considered to be particularly applicable to the IP multimedia subsystem (IMS) and Session Initiation Protocol (SIP) technology including the Push to Talk over Cellular service, as well as to the UMTS access network (i.e. GPRS—General Packet Radio Service) and other access networks e.g. WLAN, CDMA2000.

### RELATED BACKGROUND ART

The 3GPP (3rd Generation Partnership Project) release 5 introduces the IMS subsystem that has been developed to leverage the SIP technology as the basis for all IP services such as Voice over IP, among others. SIP is a rendezvous protocol used to establish media sessions between a SIP User Agent Client (UA C) and a SIP User Agent Server (UA S). To describe the session to be open, SIP is using the SDP (Session Description Protocol) protocol, hence it is possible in theory to establish a variety of sessions, depending on the used application, for both the real time services and the non-real time services. The IMS is the SIP core network, the underlying network can be whatever IP based transport network such as e.g. GPRS. According to the 3GPP's IMS release 5, a charging requirement that media level access charging information is to be available is set (i.e. how much traffic has been generated in the access network by each of the media components within a SIP session). This requirement has been set to enable the operators for a variety of business models and will be the basis for future 3GPP releases as well.

To satisfy this charging requirement, a big limitation has been set to the system in such a way that multiplexing of media components of different sessions is not allowed in release 5 networks. Moreover, multiplexing of media components of the same session that require the same bearer Quality-of-Service (QoS) can not be properly achieved, since the charging correlation mechanism is designed to offer only PDP (Packet Data Protocol) Context based granularity so that the above described requirement cannot be satisfied.

Multiplexing media components of the same SIP session as well as media components of different SIP sessions in the same PDP Context is a limitation that will be removed in the future, e.g. according to 3GPP Release 6.

However, also in the time frame according to the 3GPP release 5, most likely the available terminals will not support a sufficient number of secondary PDP Contexts. Thus, media multiplexing will perhaps be dictated by this limitation already in the time frame according to release 5.

Since the charging according to 3GPP Release 5 has been designed assuming that one media stream maps to a secondary PDP Context, it is not possible to achieve flow based charging granularity, and thus to enable the operator for a variety of business models as required according to TS 22.115 whenever the before mentioned assumption is not true anymore. It is necessary to enhance the charging correlation to enable IP flow based charging (or media based) correlation in CCF (Charging Collector Function) and OCS (Online Charging System). Moreover, it is necessary to define a mechanism to set the charging IP filter in the access network (e.g. GGSN—Gateway GPRS Support Node) that would define the “service flow(s)” to be metered.

Presently, there is no solution for the IMS flow based charging. Existing flow based charging mechanism make use of statically defined packet filters, that would not help to satisfy the IMS charging requirements (i.e. on a per session based charging), since the IP addresses and port numbers are dynamically negotiated in the SDP during SIP session establishment (i.e. unknown beforehand).

It may be considered that PLU (packet look-up) by means of a sort of SIP/SDP traffic analyzer for instance on the Gi interface or integrated into the access device (e.g. GGSN) would solve the problem by sniffing the SDP and discovering the IP addresses and port numbers. However, in IMS network SIP signaling, compression is used between the terminal and the P-CSCF (proxy connection state control function). In future releases, e.g. release 6, also confidentiality protection will be used (IPsec encrypted tunnel to P-CSCF). In the IETF (Internet Engineering Task Force) SIP network, it is possible to protect the SDP end-to-end by using sMIME (Secure/Multipurpose Internet Mail Extensions). Hence, it is not possible to rely on PLU with neither IMS network nor IETF network.

### SUMMARY OF THE INVENTION

Therefore, it is an object of the present invention to overcome the shortcomings described above and to provide a method and system for access flow based charging for IP multimedia system services.

Accordingly, the present invention is a method of flow based charging for IP multimedia system services, said system comprising at least a call processing server, and a session charging functionality, wherein the method comprises negotiating, during a session initiating signaling, media to be used within a session; and generating a set of charging flow identifiers according to a predefined mechanism, which are associated with respective charging identifiers of the IP multimedia system identifying the session, wherein a charging identifier of the IP multimedia system and a charging flow identifier globally uniquely identify a media component within a session, and wherein said call processing server and said session charging functionality generate the same charging flow identifiers by using said predefined mechanism so that the charging flow identifiers are known before any resource reservation takes place.

The method according to the present invention can be advantageously modified by performing the negotiating during a Session Initiation Protocol signaling by means of the Session Description Protocol. In this case, the Session Description Protocol may comprise several lines describing the media components that make up the session, and wherein a charging flow identifier uniquely identifies a media line within a session.

The present invention is also a system of flow based charging for IP multimedia services, said system comprising at least a call processing server and a session charging functionality, the system further comprising negotiating means for negotiating, during a session initiating signaling, media to be used within a session; and generating means for generating a set of charging flow identifiers according to a predefined mechanism, which are associated with respective charging identifiers of the IP multimedia system identifying the session, wherein said call processing server and said session charging functionality generate the same charging flow identifiers by using said predefined mechanism.

The system according to the present invention may be advantageously modified by adapting the negotiating means to perform the Session Description Protocol within the Session Initiation Protocol.

### BRIEF DESCRIPTION OF THE DRAWINGS

Further details and advantages of the present invention will become more readily apparent from the following description of the preferred embodiments which is to be taken in conjunction with the appended drawings, in which:

FIG. 1 shows the enhanced charging correlation principle according to the present invention;

FIG. 2 shows the IMS flow based charging and flow based correlation mechanism in a simplified SIP session diagram according to the present invention;

FIG. 3 shows the charging correlation process applied to off-line charging; and

FIG. 4 shows a block diagram illustrating the system according to the present invention.

### DETAILED DESCRIPTION OF THE PREFERRED EMBODIMENTS

As a preferred embodiment of the present invention, the access flow based charging is realized at the edge of the access network, e.g. in the GGSN.

In a SIP session the media are negotiated during SIP signaling by means of the SDP, wherein the call processing server P-CSCF and S-CSCF (serving connection sate control function) are SIP stateful proxies and fully aware of the media being used within the session. SCF (Session Charging Function) is usually a back-to-back user agent, stateful by nature, and also aware of the media being used within the session.

Both P-CSCF(PDF), S-CSCF and SCF generate a set of charging flow identifiers (Ch-Flow-Id) according to a predefined mechanism here described, associated with the ICID (IMS Charging Identifier) that identifies the SIP session. The 2-Tuple of ICID and Ch-Flow-Id is globally unique and uniquely identifies a media component within a SIP session.

The SDP consists of several “m:”-lines describing the media components that made up the session. The order of the “m:”-lines is not allowed to change during session set up. In order to enable media component level correlation, it is sufficient for P-CSCF(PDF), S-CSCF and SCF to generate a Ch-Flow-Id that uniquely identifies a media line within a session. To do that the “m:”-lines are numbered in increasing order from the first “m:”-line until the last “m:”-line in the SDP as follows:
m: video 49170/2 RTP/AVP->Ch-Flow-Id 1
m: voice 49174 RTP/AVP->Ch-Flow-Id 2
m: xxxxx ports protocol->Ch-Flow-Id n

The Ch-Flow_Id does not need to be transported within the SIP signaling in the IMS network, since P-CSCF(PDF), S-CSCF and SCF will end up to calculate the same identifiers by using the above described mechanism.

This way, the S-CSCF and SCF know the charging flow identifiers before resource reservation (e.g. Secondary PDP Context Activation) takes place, which is an advantage for online charging, since media component level correlation is already possible during resource reservation.

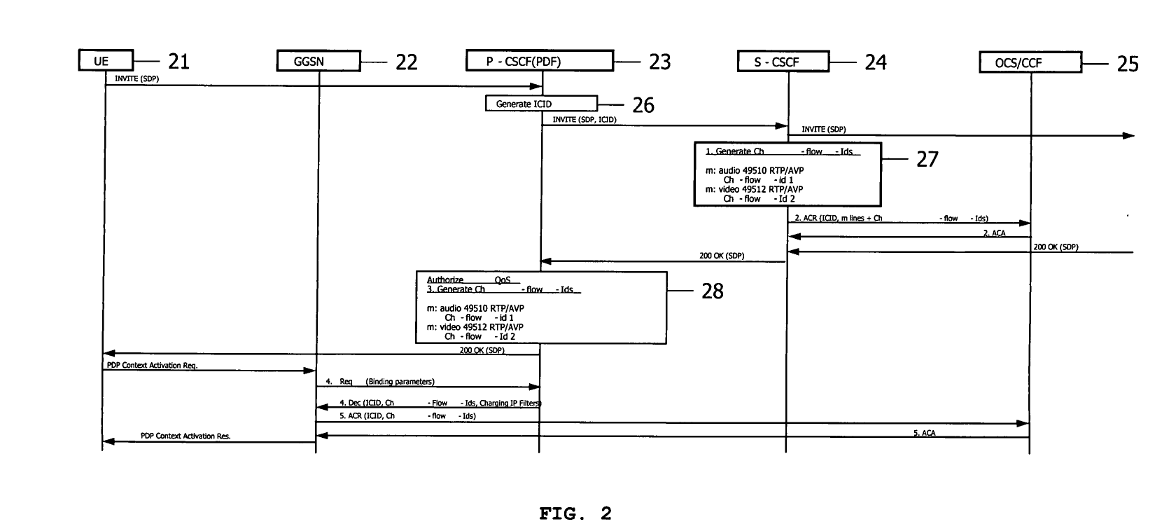

For off-line charging, the Ch-Flow-Ids are sent to the CCF via Rf interface e.g. by extending the SDP-Media-Component AVP (attribute value pair), see FIG. 2.

The Go interface is used to enable flow based charging correlation with the access network (e.g. GGSN) in a similar way as it is used to transport the ICID. However, it is necessary to extend the Go PIB (Policy Information Base) to accommodate for flow based charging as follows:

1) The ICID table needs to be extended to convey the Ch-Flow-Ids associated with the relevant ICID.

2) Each of the charging flow identifiers has a list of uplink and downlink IP filters (derived by the PDF from the SDP) to be metered associated to it. Since a list of charging IP filters is associated with the charging flow identifier, this attribute also indicates to the GGSN the aggregate IP flow that is to be metered (i.e. the IP flows specified by the IP filters associated to the Ch-Flow-Id must be metered all together). One IP filter list for the uplink direction and one for the downlink direction are given, wherein it is a GGSN implementation choice whether to use UL and DL counters or whether to meter both directions with the same counter for off-line charging.

The ICID and Ch-Flow-Ids are sent from the GGSN to the OCS in the quota reservation request upon resource reservation request and after the set of charging identifiers and associated IP filters has been received from the PDF via Go interface.

The charging correlation process in CCF and OCS makes use of the ICID and Ch-Flow-Ids to combine access charging information with IMS charging information on a per session basis and at media component level.

According to the above, the present invention presents charging support at media component level for IMS SIP sessions and media multiplexing in the same PDP Context. In other words, with the present invention it is possible to multiplex media components of different SIP sessions as well as media components of the same SIP session in the same PDP Context and still apply access charging on a per session basis and at media component level.

It is then possible to correlate, under the above mentioned conditions, access charging information with the IMS charging information generated for the same SIP session on a per session basis and at media component level.

A more detailed description of the present invention is given below by making reference to the appended drawings.

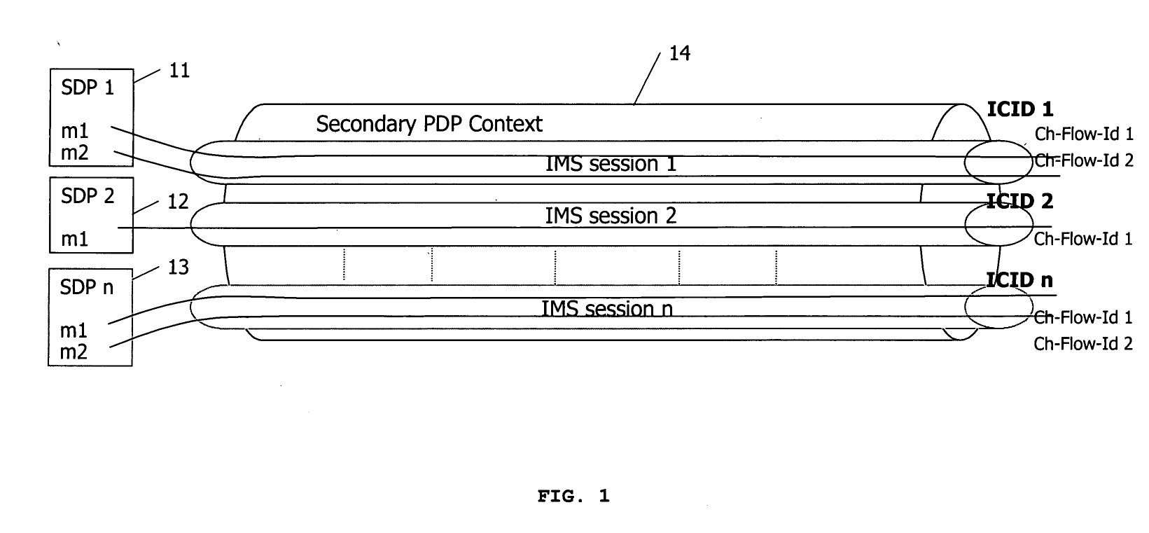

FIG. 1 shows an enhanced charging correlation, where the ICID is linked to the set of IP packet filters that define the session. The charging of flow identifiers must be used to enable access charging media component level correlation. The 2-tuple of ICID and CH-Flow-Id uniquely identifies a media component within a session. Specifically, depicted is a Secondary PDP Context 14 including IMS sessions 1, 2, . . . , n. Each of these sessions is based on a respective Session Description Protocol 1, 2, . . . , n as designated by reference numerals 11, 12 and 13. Each of the IMS sessions may comprise a number of media components, for example m1 and m2 for IMS session 1 or only m1 for IMS session 2. Thus, as stated above, while an ICID is linked to one IMS session as e.g. ICID 1 to IMS session 1, there is a Ch-Flow-Id for each of the media components within an IMS session. Hence, as can be seen from the figure, the 2-tuple of ICID and CH-Flow-Id uniquely identifies a media component within a session.

FIG. 2 shows the signaling of the IMS flow based charging and flow based correlation. Specifically, upon a session invitation from a user equipment 21 and a corresponding generation (refernce numeral 26) of an ICID by the P-CSCF(PDF) 23, as designated by reference numeral 27, the S-CSCF 24 generates (1.) the Ch-Flow-Ids according to the rules defined above. Then, the S-CSCF 24 sends (2.) the ICID and Ch-Flow-Ids to the CCF 25 and/or the Online Charging System. Next, the P-CSCF(PDF) 23 generates (3.) the Ch-Flow-Ids according to the rules defined above, as designated by reference numeral 28. Thereafter, the GGSN 22 sends (4.) the Go interface Authorization Request to the PDF including the binding information. The PDF 23 determines from the binding information the SIP session and media carried in the PDP Context (or resource reservation) and sends (4.) an Authorization Decision message including the ICID, associated Ch-Flow-Ids and charging IP filters.

The GGSN 22 meters the media flows according to the information received in the decision message from the PDF (off-line charging). Finally, the GGSN 22 requests quota to the Online Charging System 25 by sending (5.) the ICID and associated flow identifiers. The OCS 25 uses the correlation parameters to identify the SIP sessions and media components carried within the PDP context (or resource reservation). The Online Charging System 25 acknowledges (5.) to the GGSN 22 which in turn sends a PDP Context Activation Response to the User Equipment 21.

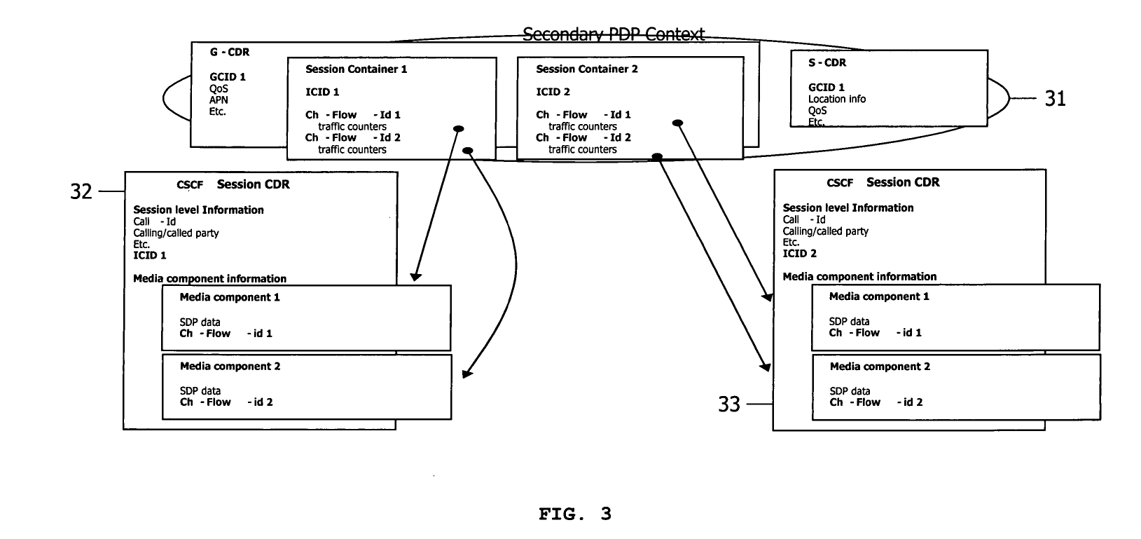

In addition, FIG. 3 shows the steps for the off-line charging correlation. In detail, FIG. 3 shows two examples of Session Charging Data Records 32, 33 of a Secondary PDP Context 31 as included in session container. As depicted, it is apparent that each media component is uniquely identified within the session by a charging identifier ICID and a charging flow identifier Ch-Flow-Id.

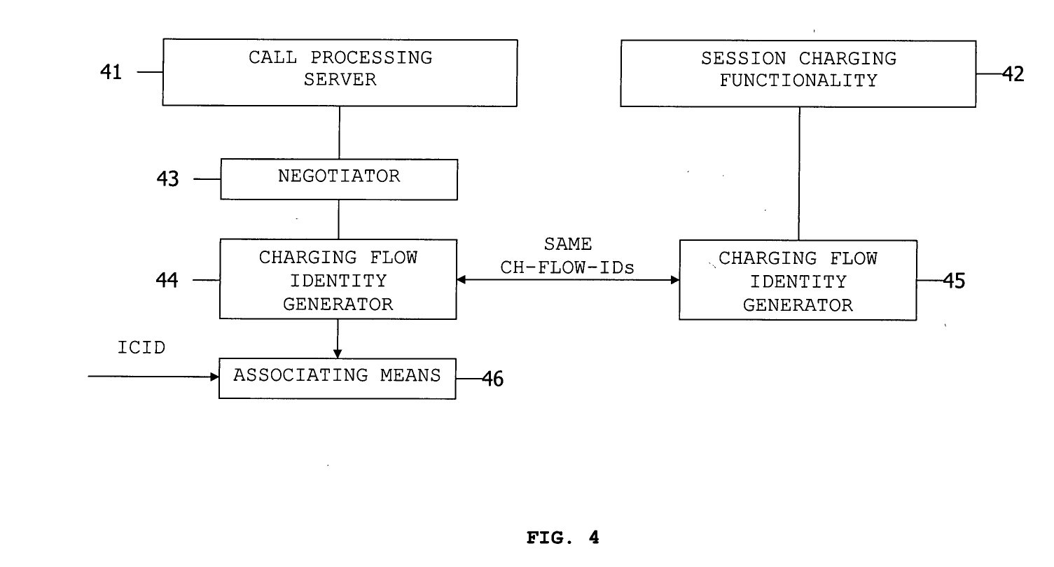

Still further, FIG. 4 shows a schematic block diagram illustrating the system according to the present invention. However, the illustration is for explanatory pruposes only, and-not intended to be limiting. Specifically, what is shown is a system of flow based charging for IP multimedia services, the system including at least a call processing server 41 and a session charging functionality 42, the system comprising negotiating means 43 for negotiating media to use within a session during a session initiating signaling; and generating means 44, 45 for generating a set of charging flow identifiers according to a predefined mechanism, wherein the set of charging flow identifiers is associated (46) with respective charging identifiers of an IP multimedia system respectively identifying a session, wherein the call processing server 41 and the session charging functionality 42 generate same charging flow identifiers by using the predefined mechanism.

Hereinafter, an implementation of the present invention as a preferred embodiment is described.

According to the IMS charging requirements specified in the technical specification “TS 22.115” of the 3^{rd} Generation Partnership Project (3GPP), charging of an IMS session requires media component level granularity. Release 5 charging mechanisms are built around the assumption that media components from different IMS sessions are not carried within the same PDP context. Additionally, a SIP level mechanism was developed for the IMS network to indicate to the user equipment UE whether a separate PDP Context is required for each IMS media component within the same IMS session. These constraints and mechanisms were triggered by the lack of standardized differentiated bearer charging capabilities.

The scope of the technical report “TR 23.825” of the 3^{rd} Generation Partnership Project (3GPP) is to define the overall architecture for such standardized capabilities for Release 6. This contribution identifies the basic capabilities to be supported in the Traffic Plane Function to allow for appropriately charging for bearers that carry traffic from several media components and/or IMS sessions.

In accordance with the present invention, it is proposed to apply the following changes to TR 23.825:

First set of changes:
“4.2 Traffic Plane Function

This refers to the filtering that identifies the service flows that need to be charged at different rates. Basic example: look for packets to and from service A.
Filtering with respect to service type based on the transport and application protocols used above IP, e.g. MMS, HTTP, WAP etc. shall be studied. This includes ability to differentiate between TCP, Wireless-TCP according to WAP 2.0, WDP, etc., in addition to differentiation at the application level.
Different filtering shall be supported for downlink and uplink
Different granularity for service filters identifying the service flow shall be possible e.g. simple filters such as based on IP address and port numbers
In the case of GPRS, the traffic plane function shall provide the ability to support simultaneous independent filtering on service flows associated with all, and each individual active PDP contexts; that is, primary and secondary PDP contexts.

For service flows carrying IMS media traffic, the Traffic Plane Function shall be able to identify both the corresponding IMS session and the corresponding media component within the session. The Traffic Plane Function uses the following information to achieve this:
ICID defined in 3G TS 32.225: IMS charging Identifier that identifies the IMS session;
Media identifier within the Flow ID defined in 3G TS 29.207: identifies the media component (defined by the ‘m=’ line in the SDP) within an IMS session;”

Second set of changes:

“4.6 Charging models

When developing the charging solutions, the following charging models should be considered, even though the full solution to support the models may not be within the scope of this TR.

Shared revenue services shall be supported. In this case settlement for all parties shall be supported, including the third parties that may have been involved providing the services.

Charging models where service flow charging depends on the volume of data shall be supported, as well as those where service flow charging depends on the time of day.

It shall be possible to restrict special rates to a specific service, e.g. allow the user to download a certain volume of data from one service for free, but this allowed volume is not transferable to other services.

In case of GPRS, it shall be possible to apply differentiated bearer level charging for the individual IMS sessions and media components even if the media traffic of several different media components and IMS sessions is carried in the same PDP Context.”

That is, what is described above is a method for flow based charging for IP multimedia system services, said system comprising at least a call processing server, and a session charging functionality, wherein the method comprises negotiating, during a session initiating signaling, media to be used within a session; and generating a set of charging flow identifiers according to a predefined mechanism, which are associated with respective charging identifiers of the IP multimedia system identifying the session, wherein a charging identifier of the IP multimedia system and a charging flow identifier globally uniquely identifies at least two media components within a session, and wherein said call processing server and said session charging functionality generate the same charging flow identifiers by using said predefined mechanism so that the charging flow identifiers are known before any resource reservation take place.

While it has been described above what is presently considered to be preferred embodiments of the present invention it is to be understood that the same is give by way of example only and that various modifications can be made without departing from the scope of the appended claims.

1. A method of flow based charging for IP multimedia system services, using at least a call processing server, and a session charging functionality, the method comprising:
negotiating media to use within a session during a session initiating signaling; and
generating a set of charging flow identifiers according to a predefined mechanism, wherein the set of charging flow identifiers are associated with respective charging identifiers of an IP multimedia system respectively identifying a session,
wherein a charging identifier of the IP multimedia system and a charging flow identifier globally uniquely identify a media component within the session, and
wherein a call processing server and a session charging functionality generate same charging flow identifiers by using said predefined mechanism so that the charging flow identifiers are known before any resource reservation occurs.

2. The method according to claim 1, wherein the negotiating comprises performing during a session initiation protocol signaling by means of a session description protocol.

3. The method according to claim 2, wherein the performing comprises performing during the session initiation protocol, in which the session description protocol comprises several lines describing media components that comprise the session, and wherein the charging flow identifier uniquely identifies a media line within the session.

4. A system of flow based charging for IP multimedia services, said system, including at least a call processing server and a session charging functionality, the system comprising:
negotiating means for negotiating media to use within a session during a session initiating signaling; and
generating means for generating a set of charging flow identifiers according to a predefined mechanism, wherein the set of charging flow identifiers are associated with respective charging identifiers of an IP multimedia system respectively identifying a session,
wherein a call processing server and a session charging functionality generate same charging flow identifiers by using said predefined mechanism.

5. The system according to claim 4, wherein the negotiating means perform a session description protocol within a session initiation protocol.

6. A method for flow based charging for IP multimedia system services, using at least a call processing server, and a session charging functionality, the method comprising:
negotiating media to use within a session during a session initiation signaling;
generating a set of charging flow identifiers according to a predefined mechanism, wherein the set of charging flow identifiers are associated with respective charging identifiers of an IP multimedia system respectively identifying a session;
identifying a media component within the session with a charging identifier of the IP multimedia system and a charging flow identifier that globally uniquely identifies the media component; and
generating same charging flow identifiers by using said predefined mechanism so that the charging flow identifiers are known before any resource reservation occurs with a call processing server and a session charging functionality.

7. The method according to claim 6, wherein the negotiating comprises performing during a session initiation protocol signaling by means of a session description protocol.

8. The method according to claim 7, wherein the performing comprises performing during the session initiation protocol, in which the session description protocol comprises several lines describing media components that comprise the session, and wherein the charging flow identifier uniquely identifies a media line within the session.

9. A system for flow based charging for IP multimedia services, the system comprising:
a call processing server;
a session charging functionality;
a negotiator to negotiate media to use within a session during a session initiating signaling;
charging flow identifier generator to generate a set of charging flow identifiers according to a predefined mechanism; and
associating means for associating the set of charging flow identifiers with respective charging identifiers of an IP multimedia system respectively identifying a session,
wherein the call processing server and the session charging functionality generate same charging flow identifiers by using said predefined mechanism.

10. The system according to claim 9, wherein the negotiator performs a session description protocol within a session initiation protocol.

11. The system according to claim 10, wherein the session description protocol comprises several lines describing media components that comprise the session, and wherein the charging flow identifier uniquely identifies a media line within the session.
